(19) United States
(12) Patent Application Publication
(10) Pub. No.: US 2008/0052744 A1
(43) Pub. Date: Feb. 28, 2008

(54) Scheduling Device, Instruction Method for Recording of Scheduled Content, and Recording Device

(76) Inventor: Hiroshi Hamasaka, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/570,251

(22) PCT Filed: Jun. 9, 2005
(86) PCT No.: PCT/JP05/10603

§ 371 Date: Dec. 8, 2006

(30) Foreign Application Priority Data
Jun. 11, 2004 (JP) 2004-173506

(51) Int. Cl. G06F 3/00

(52) U.S. Cl. 725/58

(57) ABSTRACT

When a recording of a content such as a program is scheduled, recording failure are significantly reduced, and viewing of the content is guaranteed, while ensuring privacy protection for the user who has made the schedule. A scheduling device instructs recording device(s) interconnected via a network to record content(s) based on scheduling information which contains identification (ID) information of a removable medium on which the content is to be recorded, and time information specifying a recording start and end times of the content. The device includes: a storing section for storing the scheduling information; a communication section for acquiring, from one of recording devices which can mount the removable medium, ID information specifying a removable medium mounted a predetermined amount of time before the recording start time; and a control section for executing comparison between the acquired ID information and the ID information contained in the scheduling information, and giving an instruction to record the content based on comparison result.

### TECHNICAL FIELD

The present invention relates to a technique of recording a content by utilizing a network environment. More specifically, the present invention relates to a technique of recording a content on a specific recording device in accordance with recording conditions as scheduled.

### BACKGROUND ART

With the permeation of networks, it has become possible to perform scheduling of television broadcast programs on a video device at one's home, via a network, from a terminal such as a mobile phone or a PC. For example, Patent Document 1 proposes a scheduled videorecording service in which scheduling of recording of a program is performed via a network.

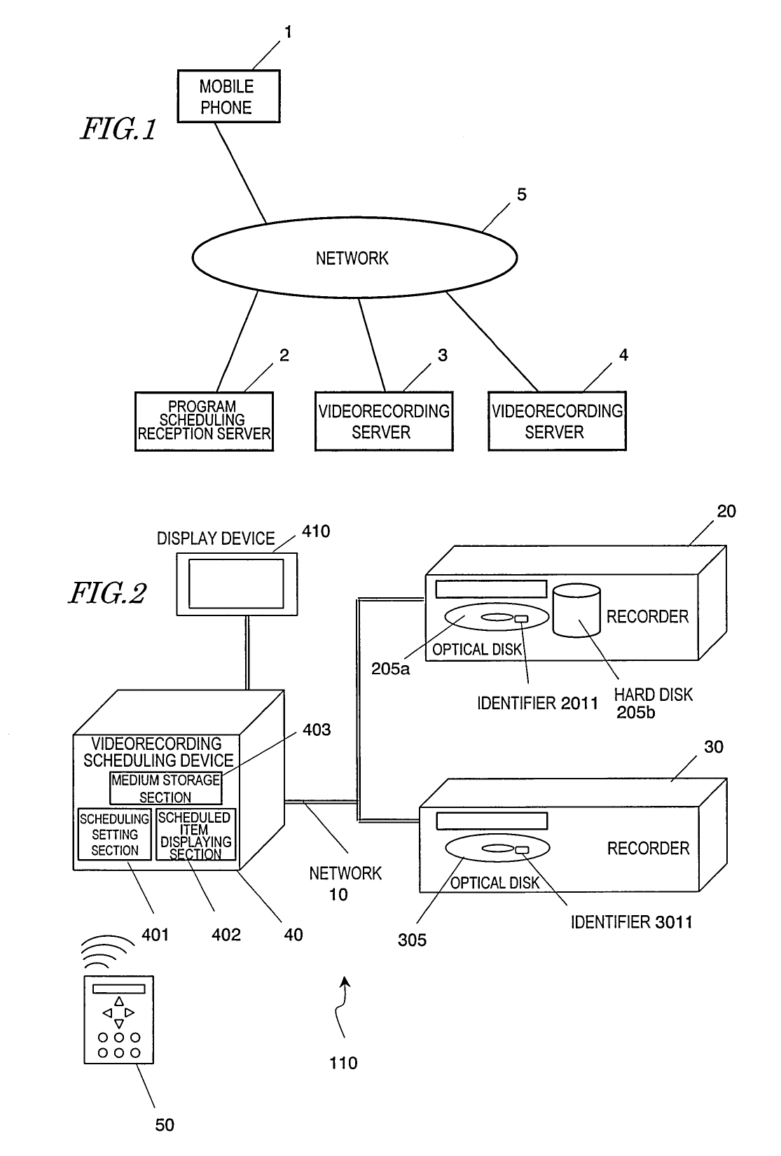

Now, a conventional scheduled videorecording service will be briefly described. FIG. 1 shows the arrangement of a conventional scheduled videorecording service system which utilizes a network. A mobile phone 1 which is a scheduling terminal, a program scheduling reception server 2, and videorecording servers 3 and 4 are interconnected via a network 5. Via the network 5, a user accesses the program scheduling reception server 2 from the mobile phone 1 to perform scheduling of recording of broadcast programs. In accordance with the information (scheduling information) of the broadcast programs whose recording is scheduled, the program scheduling reception server 2 performs scheduling of videorecording with respect to the videorecording servers 3 and 4. Each of the videorecording servers 3 and 4 records each broadcast program by utilizing the details of scheduled videorecording as well as a program guide of broadcast programs which are broadcast from a broadcast station. Specifically, a videorecording file is generated on a storage medium (such as a HDD or a DVD-RAM) to store the data of each program. For example, commonly-used recording device intended for individual users function as videorecording servers.

The videorecording servers 3 and 4 are distinguished by their URLs, which are addresses on the network. As the user accesses the program scheduling reception server 2 to cause a screen to be displayed on the mobile phone 1, a PC, or the like, a URL is obtained that indicates which videorecording server each program has been recorded to. As a result, it is possible to identify the videorecording server on which a program has been recorded through scheduling. Furthermore, by accessing this videorecording server, it is possible to know a videorecording file which corresponds to the program which has been videorecorded through scheduling. Since scheduling of recording of a program is performed and recording is executed via a network, a user can perform scheduling of recording of a program without having to be present in front of the videorecording device, and later enjoy the videorecorded program.

[Patent Document 1] Japanese Laid-Open Patent Publication No. 2002-135699

### DISCLOSURE OF INVENTION

Problems to be Solved by the Invention

However, various problems may occur if a recording device which is intended for individual users is used as a videorecording server in a scheduled videorecording service. These problems are outstanding on a recording device which utilizes an exchangeable storage medium.

In other words, if a DVD recorder which performs recording on exchangeable DVDs is used as a videorecording server, the chances of failing in scheduled videorecording are increased. For example, the user may forget to mount a DVD on the DVD recorder. Even if a DVD is mounted, it may be write-protected so as to prohibit writing to the DVD, or the disk capacity may not have sufficient vacancy. Since videorecording will not be executed in any of these cases, the user who has set the scheduling will suffer from significant disadvantages.

Furthermore, even if videorecording is normally performed, the user who has set the scheduling may not be able to enjoy the program which he or she has scheduled, and/or appropriate privacy protection may not be attained. Specifically, a conventional DVD recorder will execute videorecording so long as any DVD that is recordable and has a sufficient disk capacity is mounted. At this time, no consideration is given as to whether the mounted DVD belongs to a user that is different from the user who has performed the scheduling or not. Therefore, the owner of the DVD will have an unexpected program to be recorded thereon, thus leading to the possibility that the program may be erased. The user who has performed the scheduling will not only be unable to view the program, but also allow the owner of the DVD to know the substance of the program which has been recorded through scheduling.

Furthermore, since the scheduling of videorecording is to be performed by designating a DVD recorder, in the case where the user owns two or more DVD recorders, it is necessary to mount a DVD properly on the DVD recorder to which scheduling of videorecording has been performed. If the user should inadvertently mount a DVD on another DVD recorder, videorecording will never be performed.

An objective of the present invention is to, when a recording of a content such as a program is scheduled, significantly reduce failures in the recording, and guarantee viewing of the content, while ensuring privacy protection for the user who has performed the scheduling.

Means for Solving the Problems

A scheduling device according to the present invention instructs one of one or more recording devices which are interconnected via a network to record a content based on scheduling information. The scheduling information contains identification information of a removable storage medium on which the content is to be recorded, and time information specifying a recording start time and a recording end time of the content. The scheduling device comprises: a storing section for storing the scheduling information; a communication section for acquiring, from a recording device among the one or more recording devices that is capable of mounting the removable storage medium, identification information specifying a removable storage medium which is mounted a predetermined amount of time before the recording start time; and a control section for executing a comparison between the acquired identification information and the identification information contained in the scheduling information, and giving an instruction to record the content based on a result of comparison.

When the result of comparison indicates a match, the control section may instruct the recording device having the removable storage medium mounted therein to record the content.

The control section may transmit the scheduling information to the recording device which is instructed to record the content, and instruct the recording device to record in accordance with the scheduling information.

A recording device having a non-removable storage medium which is capable of recording the content may be connected to the network; and, when the result of comparison indicates a non-match, the control section may instruct the recording device having the non-removable storage medium to record the content.

From the recording device having the removable storage medium mounted therein, the communication section may further acquire write protection information indicating whether recording to the removable storage medium is prohibited or permitted; and, based on the write protection information, the control section may instruct the recording device having the removable storage medium mounted therein to record the content when recording is permitted, and instruct the recording device having the non-removable storage medium to record the content when recording is prohibited.

From the recording device having the removable storage medium mounted therein, the communication section may further acquire remaining duration information indicating a remaining recordable duration on the removable storage medium; and, based on the time information and the remaining duration information, the control section may instruct the recording device having the removable storage medium mounted therein to record the content when recording the entire content to the removable storage medium is possible, and instruct the recording device having the non-removable storage medium to record the content when recording is impossible.

The scheduling device may further comprise a signal processing section for generating a notification signal for notifying a completion of recording when the recording of the content to the non-removable storage medium has been completed.

After the recording of the content to the non-removable storage medium is completed, the communication section may again acquire, from the recording device that is capable of mounting the removable storage medium, identification information specifying a removable storage medium mounted therein; and the control section may execute the comparison based on the identification information acquired again and the identification information contained in the scheduling information, and when determining that recording of the content to the removable storage medium is possible based on a result of comparison, instruct the recording device having the non-removable storage medium and the recording device having the removable storage medium to move the content from the non-removable storage medium to the removable storage medium.

The communication section may again acquire the identification information from a recording device that is capable of mounting the removable storage medium and has the non-removable storage medium.

A method according to the present invention is used for instructing one of one or more recording devices which are interconnected via a network to record a content based on scheduling information. The scheduling information contains identification information of a removable storage medium on which the content is to be recorded, and time information specifying a recording start time and a recording end time of the content. The method comprises: a step of acquiring the scheduling information; a step of acquiring, from a recording device among the one or more recording devices that is capable of mounting the removable storage medium, identification information specifying a removable storage medium which is mounted a predetermined amount of time before the recording start time; a step of executing a comparison between the acquired identification information and the identification information contained in the scheduling information; and a step of giving an instruction to record the content based on a result of comparison.

A recording device according to the present invention executes a recording of a content to a removable storage medium mounted therein, based on an instruction from a scheduling device which is interconnected via a network. The removable storage medium retains identification information for identifying individual removable storage media. The recording device comprises: a communication section for communicating with the scheduling device; a drive control section for reading identification information of a mounted removable storage medium; and a control section for, based on an instruction from the scheduling device to transmit the identification information, giving an instruction to read the identification information and giving an instruction to transmit the identification information having been read. Based on an instruction from the scheduling device to record the content, the control section gives an instruction to record the content onto the removable storage medium, and based on the instruction from the control section, the drive records the content onto the removable storage medium.

The recording device may further comprise a non-removable storage medium capable of recording the content. From the scheduling device, the communication section may receive the instruction to record the content together with an instruction specifying a storage medium on which the content is to be recorded; and, based on the instruction, the drive control section may record the content onto one of the non-removable storage medium and the removable storage medium.

After the recording of the content onto the removable storage medium is completed, the control section may generate a signal for displaying a listing of all contents that are recorded on the removable storage medium and the non-removable storage medium.

The control section may generate the listing by arranging, in associated with each other, the identification information of the removable storage medium and time information concerning a point of time at which the recording was performed.

The control section may generate the listing without utilizing data of an electronic program guide which is contained in a broadcast wave.

### EFFECTS OF THE INVENTION

According to the present invention, by distinguishing one storage medium from another storage medium by using identifiers on the storage media, it is possible to execute a scheduled information recording irrespective of which recording/reproduction device has the target storage medium mounted therein.

Further according to the present invention, since it is possible to execute a scheduled information recording irrespective of which recording/reproduction device the storage medium is mounted in, a user can perform a scheduling by designating a storage medium, without paying attention to which recording/reproduction device the target storage medium is mounted in.

Further according to the present invention, an error is notified to the user when a recording to the target storage medium based on scheduling is impossible. Furthermore, by performing an emergency recording on another storage medium, it becomes possible to prevent the scheduling from failing.

Further according to the present invention, when performing an emergency recording on another storage medium, a fixed medium is set as a destination of emergency recording with a higher priority over an exchangeable medium, whereby the user can be prevented from becoming unable to access a medium on which an emergency recording of the information has been made.

Further according to the present invention, after an emergency recording on another storage medium has been performed, an insertion of a storage medium which was the original target (in order to move the information of what has been subjected to an emergency recording on the target storage medium) is automatically detected, so that the user can easily obtain the originally intended videorecording state.

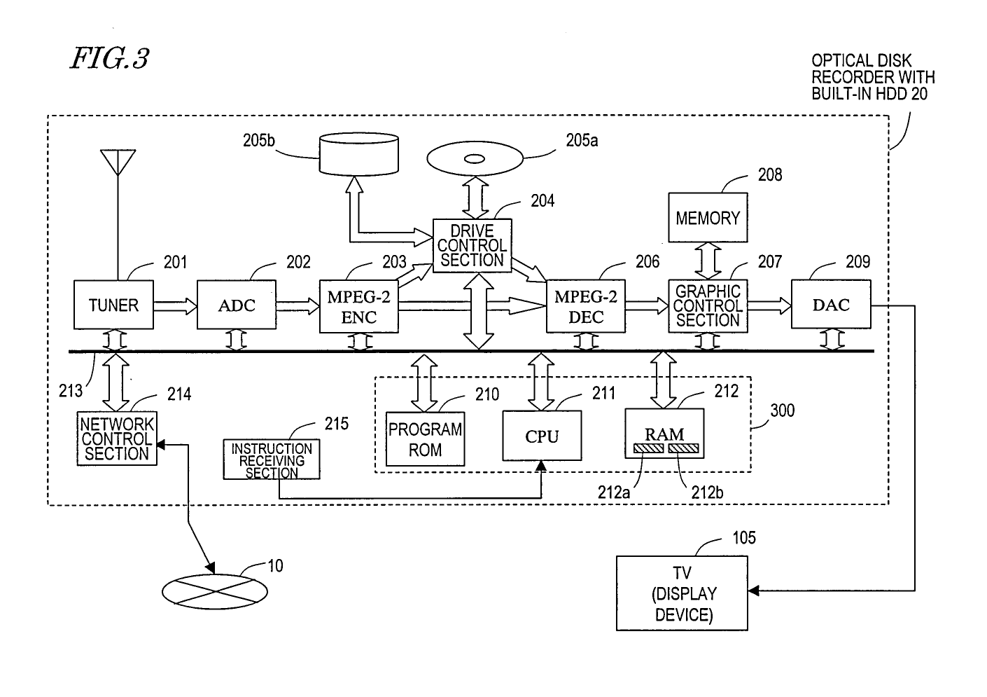

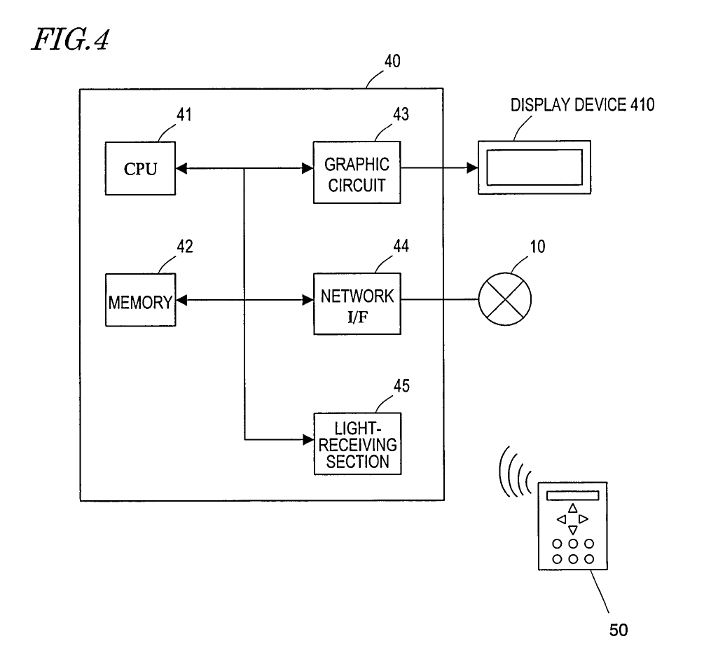

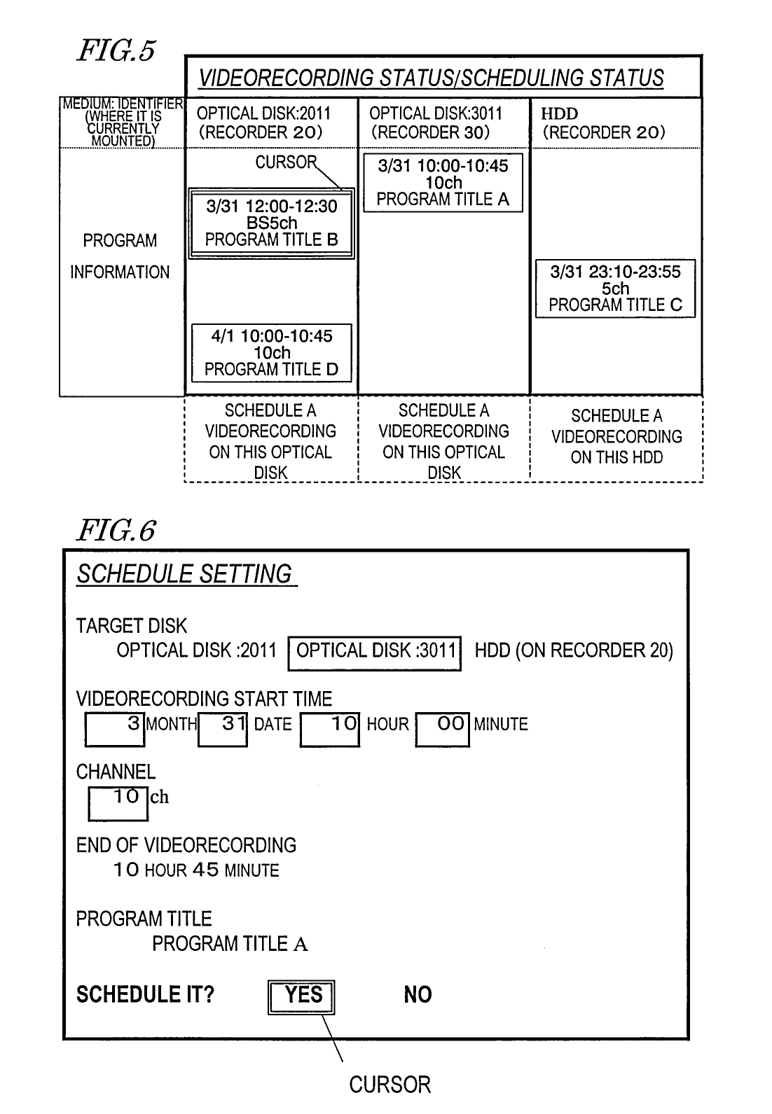

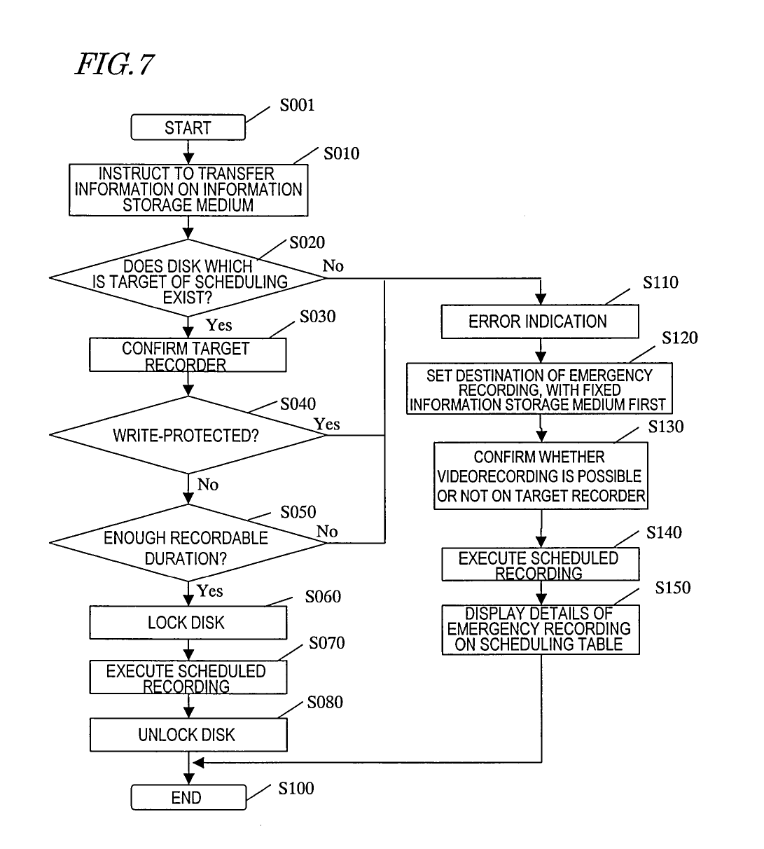

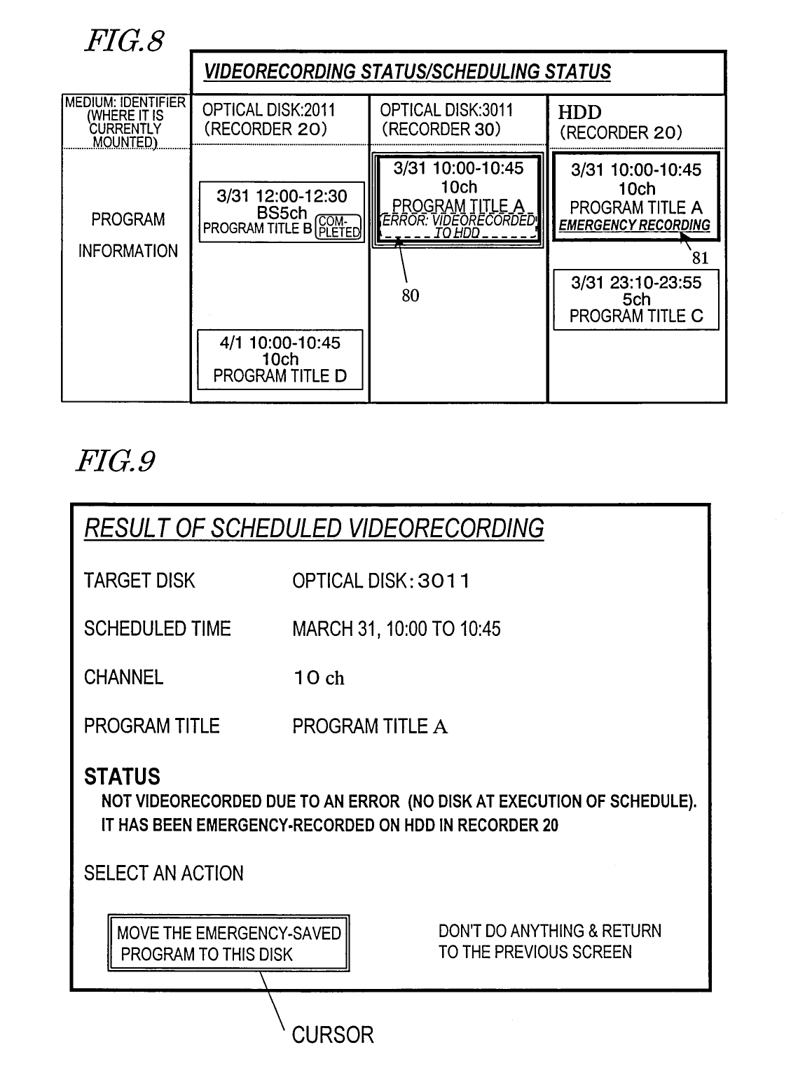

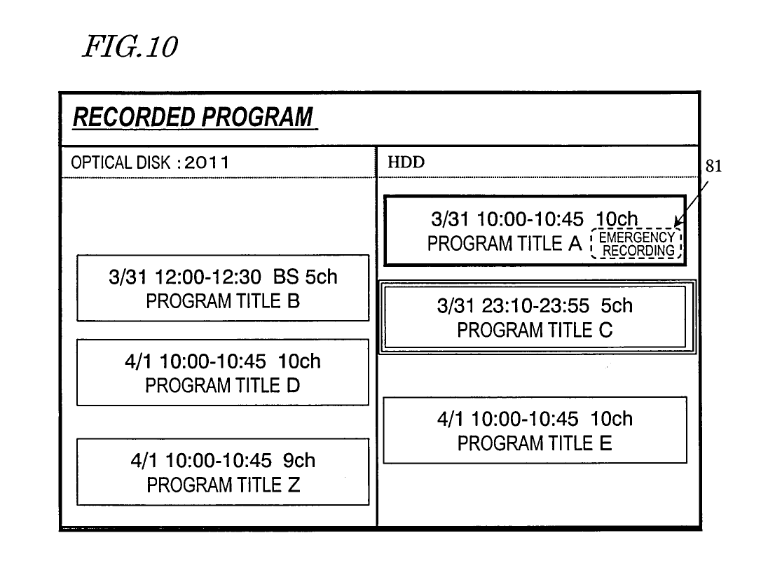

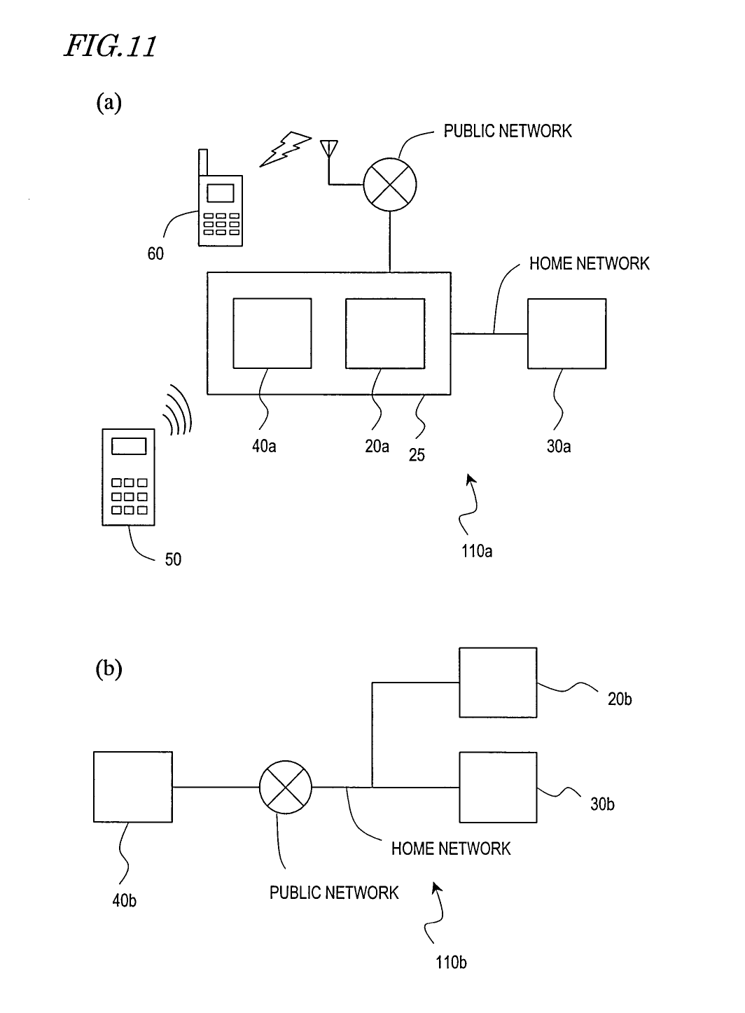

### BRIEF DESCRIPTION OF DRAWINGS

[FIG. 1] A diagram showing the arrangement of a conventional scheduled videorecording service system which utilizes a network.

[FIG. 2] A diagram showing the arrangement of a scheduling system 110 according to an embodiment of the present invention.

[FIG. 3] A diagram showing the arrangement of functional blocks of a recorder 20 according to an embodiment of the present invention.

[FIG. 4] A diagram showing the hardware arrangement of a videorecording scheduling device 40.

[FIG. 5] A diagram showing an exemplary display screen of videorecording status/scheduling status.

[FIG. 6] A diagram showing an exemplary scheduling setting screen when a program whose title is “A” is to be scheduled with respect to an optical disk 305 having an identifier “3011”.

[FIG. 7] A flowchart showing a procedure of processing by a scheduling setting section 401 in the videorecording scheduling device 40.

[FIG. 8] A diagram showing an exemplary display screen which includes an error indication 80 for an optical disk having an identifier “3011” and an alert indication 81 of an emergency recording.

[FIG. 9] A diagram showing exemplary display screen of a result of a scheduled videorecording with respect to a program for which the error indication 80 has been given.

[FIG. 10] A diagram showing an exemplary display screen of a listing of recorded programs, which has been generated by the recorder 20.

[FIG. 11] (a) is a diagram showing the arrangement of a second scheduling system 110a according to the present invention; and (b) is a diagram showing the arrangement of a third scheduling system 110b according to the present invention.

### DESCRIPTION OF REFERENCE NUMERALS

10 network

20, 30 recorder

40 videorecording scheduling device

50 remote control

110 scheduling system

205a, 305 optical disk

205b hard disk

401 scheduling setting section

402 scheduled item displaying section

403 medium storage section

410 display device

### BEST MODE FOR CARRYING OUT THE INVENTION

Hereinafter, with reference to the accompanying figures, the arrangement of a content scheduling system as well as a scheduling device and recording devices composing the scheduling system will be described.

FIG. 2 shows the arrangement of a scheduling system 110 according to the present embodiment. In the scheduling system 110 according to the present embodiment, the user sets scheduling of recording of a broadcast program, and based on the conditions having been set, the broadcast program is recorded onto a predetermined storage medium. As a condition, a storage medium to become a recording target can be designated. If it is detected that the designated storage medium is recordable, the program is recorded onto that storage medium. On the other hand, if the storage medium having been set is not in a recordable state (e.g., unmounted, write-protected, or short of recording capacity), a recording device having a fixed medium such as a hard disk is searched for, and that program is temporarily recorded onto that fixed medium. A recording of a content by using a storage medium which is different from a storage medium which was originally set will be referred to as an “emergency recording”.

In a recording/reproduction device that includes the storage medium to which the content has been emergency-recorded, a scrambling which can only be cancelled by the user who has performed the videorecording is applied, so that no other user can access the recorded substance on the storage medium which is the emergency saving destination. As a result, the privacy of the user who has set the scheduling is protected.

The scheduling system 110 includes a recorder 20, a recorder 30, and a videorecording scheduling device 40, which are directly interconnected via a network 10. The connections may be wired or wireless. The network 10 may be a public circuit network or a home network which is constructed within a household. Other exemplary arrangements of the scheduling system 110 will be described later with reference to FIGS. 11(a) and (b). Note that FIG. 2 illustrates a display device 410; in the following, the display device 410 will also be regarded as part of the scheduling system 110.

The recorder 20 is able to record a program onto an optical disk 205a, which is an information storage medium that can be exchanged (removable storage medium), and also onto a hard disk 205b, which is an information storage medium that is not exchangeable (non-removable storage medium). The optical disk 205a may be a DVD-RAM, for example. Based on an instruction from the videorecording scheduling device 40, the recorder 20 records a program onto either one of the optical disk 205a and the hard disk 205b. Moreover, an optical disk 305 which is a removable storage medium is mounted on the recorder 30. The optical disk 305 may be a DVD-RAM, for example.

The optical disk 205a has an identifier “2011”, whereas the optical disk 305 has an identifier “3011”. Each identifier is a value which permits unique identification from each other. In the present embodiment, it is assumed that the identifier is a number which is uniquely assigned to each optical disk, the number being recorded in an area of the optical disk called BCA (Burst Cutting Area). For details of BCA, see International Publication No. WO97/14144.

The videorecording scheduling device 40 has a scheduling setting section 401, a scheduled item displaying section 402, and a medium storage section 403. The display device 410 is connected to the videorecording scheduling device 40. While watching a screen on the display device 410, the user is able to select, finalize or correct a scheduled item, by using a remote control 50 or the like.

The above descriptions are directed to the functions and arrangement, in part, of the recorders 20 and 30 and the videorecording scheduling device 40. The detailed hardware arrangements, functions, operations, etc., of the respective component elements of the scheduling system 110 will be clarified in the descriptions below.

First, with reference to FIG. 3, the detailed hardware arrangement of the recorder 20 will be described. Note that the description of the recorder 20 also applies to the recorder 30, except that any arrangement or process that relates to the hard disk 205b does not apply to the recorder 30 because the recorder 30 does not include a hard disk.

FIG. 3 shows the arrangement of functional blocks of the recorder 20 of the present embodiment. The recorder 20 has a function of receiving a signal of a program which is transmitted from a broadcast station, and recording a data stream which is generated based on that signal onto the optical disk 205a or the hard disk 205b, i.e., a function of recording a program. Note that the signal of a program to be received may be a signal of an analog broadcast program, or a signal of a digital broadcast program. FIG. 3 shows a arrangement for recording an analog broadcast program.

Hereinafter, the functions of the respective component elements of the recorder 20 will be described, followed by a description of the processing by the recorder 20.

The recorder 20 includes a tuner 201, an AD converter 202, an MPEG-2 encoder 203, a drive control section 204, an MPEG-2 decoder 206, a graphic control section 207, a memory 208, a DA converter 209, a CPU bus 213, a network control section 214, an instruction receiving section 215, and a system control section 300. Although FIG. 1 illustrates the optical disk 205a as being within the recorder 20, the optical disk 205a is removable from the recorder 20, and is not a component element of the recorder 20 itself.

Firstly, based on scheduling information, the system control section 300 outputs an instruction to start videorecording and an instruction to end videorecording. Based on these instructions, the other component elements execute scheduled videorecording. The system control section 300 operates mainly on the basis of a CPU 211, a program ROM 210, and a RAM 212.

The tuner 201 tunes to and receives an analog broadcast wave which is transmitted from a broadcast station, and outputs video and audio signals of a program to the AD converter 202. The AD converter 202 subjects the input signal to a digital conversion before supplying it to the MPEG-2 encoder 203. Upon receiving an instruction to start videorecording, the MPEG-2 encoder 203 (hereinafter referred to as the “encoder 203”) encodes the supplied digital data into the MPEG-2 format, generates an MPEG-2 program stream (hereinafter referred to as the “program stream”) which complies with the DVD video-recording standard, and inputs it to the drive control section 204. This process is continued until the encoder 203 receives an instruction to end videorecording. In order to perform encoding, the encoder 203 has a buffer (not shown) or the like for temporarily retaining frame data and the like.

By utilizing an optical head (not shown), the drive control section 204 controls a data write process to the optical disk 205a, and a data read process from the optical disk 205a. Moreover, by utilizing a magnetic head (not shown), the drive control section 204 controls the data write process to the hard disk 205b, and the data read process from the hard disk 205b.

Upon receiving an instruction to start videorecording, the drive control section 204 performs a videorecording starting process, and thereafter receives the program stream to start writing to the optical disk 205a or the hard disk 205b. After receiving an instruction to end videorecording, if there is no more incoming program stream, the drive control section 204 ends the write process, and performs a videorecording ending process. The reason why the write process is performed until there is no more incoming program stream is that the data which is under processing in the encoder 203 will keep being output even after the videorecording end time is reached. Although it is illustrated that the drive control section 204 controls exchanges of information with respect to both the optical disk 205a and the hard disk 205b, the drive control section 204 may be provided for each of the drive device of the optical disk 205a and the drive device of the hard disk 205b.

On the other hand, when reproducing a recorded program, the drive control section 204 reads data while placing the optical disk 205a or the hard disk 205b in a state which enables reproduction. The drive control section 204 outputs to the MPEG-2 decoder 206 the data which has been read. The MPEG-2 decoder 206 (hereinafter referred to as the “decoder 206”) expands the MPEG-2 encoded data having been supplied, and converts it into uncompressed data, which is then supplied to the graphic control section 207. The graphic control section 207 has the memory 208 for internal operations connected thereto, thus realizing an On Screen Display (OSD) function. For example, the graphic control section 207 merges various menu images with the video for output to the DA converter 209. The DA converter 209 subjects the input OSD synthetic image and the audio data to an analog conversion for output.

The CPU bus 213 is a path for transmitting signals within the recorder 20. The tuner 201, the AD converter 202, the encoder 203, the drive control section 204, the decoder 206, the graphic control section 207, and the DA converter 209 are connected to the CPU bus 213. To the CPU bus 213, the component elements of the system control section 300 (described later) are also connected.

The network control section 214 has an interface function for connecting the recorder 20 to the network 10, and transmits and receives data via the network 10. This data is scheduling information which has been transmitted by the user via the network 10. The instruction receiving section 215 is a switch for performing operations such as tuning, videorecording, and reproduction on the recorder 20. The instruction receiving section 215 may further include input devices such as a keyboard for receiving search data from the user and a mouse with which to select a piece of search data. Note that the network control section 214 is connected to the CPU 211 (described below) of the system control section 300 via the CPU bus 213, whereas the instruction receiving section 215 is directly connected to the CPU 211. Signals which are generated by operating the instruction receiving section 215 are supplied to the CPU 211.

The system control section 300 controls the overall processing, including how signals flow within the recorder 20. The system control section 300 has the program ROM 210, the CPU 211, and the RAM (memory) 212, which are connected to the CPU bus 213. A software program for controlling the recorder 20 is stored in the program ROM 210.

By reading and executing the program, the CPU 211 generates control signals for realizing processes which are defined based on the program, and outputs the control signals to the respective component elements via the CPU bus 213. The memory 212 has a work area for storing data which is necessary for the CPU 211 to execute the program. For example, the CPU 211 utilizes the CPU bus 213 to execute the software in the program ROM 210. Moreover, the memory 212 stores scheduling information 212a, and also stores result information 212b, which indicates, after the end of a videorecording, whether the videorecording has been normally ended or abnormally ended.

The instruction receiving section 215 is connected to the CPU 211, and directly receives instructions concerning tuning, videorecording, reproduction, clock adjustment, scheduling registration, and the like for the recorder 20 from the user.

Next, the processing by the recorder 20 will be described. Via the network 10 and the network control section 214, the CPU 211 of the recorder 20 receives from the videorecording scheduling device 40 an instruction to transmit an identifier of a removable storage medium that is mounted at the moment. Accordingly, the CPU 211 instructs the drive control section 204 to read an identifier of the optical disk 205a. The CPU 211 instructs the network control section 214 to transmit the identifier having been read to the videorecording scheduling device 40. Thereafter, the CPU 211 receives from the scheduling device 40 an instruction to record a program. At this time, an instruction as to whether it is to be recorded onto the optical disk 205a or recorded onto the hard disk 205b is also received. Based on this instruction, the drive control section 204 records the program onto the optical disk 205a or the hard disk 205b.

After completion of videorecording, the CPU 211 generates a listing of all contents that have been recorded onto the optical disk 205a and the hard disk 205b. The specific process may be performed by the graphic control section 207, for example. Once a signal for displaying the listing is generated, the recorder 20 outputs this signal to a display device or the like. In the displayed listing, identifiers and times of recording are arranged in association with each other, so that the user can easily confirm the substance of each recorded program. The substance of the listing can be easily realized by utilizing, for example, the information and description style of programs as described in an electronic program guide (EPG), which is contained in broadcast wave(s). However, in order to realize an EPG function, processing circuitry for performing analysis of EPG data and the like would be required, thus resulting in an increase in cost. If the arrangement, etc., of the listing is adjusted by utilizing the CPU 211, the graphic control section 207, and the like that already exist, no hardware/function for acquiring and analyzing EPG data will be required. As a result, increase in the price of the recorder 20 can be suppressed.

In the following description, it will be illustrated that the titles of programs are acquired by utilizing an EPG function. However, in the case where the recorder 20 does not have an EPG function, the user may input program titles before or after recording by himself or herself, or the acquisition of program titles may be omitted.

Next, with reference to FIG. 4, the arrangement of the videorecording scheduling device 40 will be specifically described. FIG. 4 shows the hardware arrangement of the videorecording scheduling device 40. The videorecording scheduling device 40 includes a central processing unit (CPU) 41, a memory 42, a graphic circuit 43, a network interface (I/F) 44, and a light-receiving section 45.

The CPU 41 is a control unit which controls the entire operation by giving instructions to each component element of the videorecording scheduling device 40. The memory 42, which is e.g. an SRAM, retains scheduling information which specifies scheduled items. The scheduling information includes an identifier specifying an optical disk onto which a broadcast program is to be recorded, as well as time information specifying a recording start time and a recording end time of the broadcast program, channel information of the broadcast program, and the like. Herein, the “recording start time” and the “recording end time” may read as “broadcasting start time” and “broadcasting end time” instead. The graphic circuit 43 generates an image to be displayed on the display device 410, and outputs a video signal. For example, this image is a setting screen for scheduling of videorecording, a setting changing screen, a result displaying screen showing a result of an executed schedule, or the like. The network I/F 44 communicates with other devices which are connected via the network 10. The light-receiving section 45 receives an infrared signal from the remote control 50, and outputs a command based on this signal to the CPU 41.

Now, it will be described how the hardware arrangement of the videorecording scheduling device 40 shown in FIG. 4 corresponds to the functional block arrangement of the videorecording scheduling device 40 as shown in FIG. 2. First, the scheduling setting section 401 of FIG. 2 corresponds to the functions of the CPU 41 and the network I/F 44 in FIG. 4. The scheduled item displaying section 402 of FIG. 2 corresponds to the functions of the CPU 41, the memory 42, the light-receiving section 45, and the graphic circuit 43 in FIG. 4. The medium storage section 403 of FIG. 2 corresponds to the memory 42 in FIG. 4.

Next, the outline of the processing by the videorecording scheduling device 40 will be described. The videorecording scheduling device 40 stores scheduling information which has been input via the remote control 50 to the memory 42. Then, a predetermined amount of time before (e.g., 10 minutes before) the recording start time, via the network I/F 44, the CPU 41 requests to the recorder 20 and the recorder 30 for identifiers of optical disks which are mounted therein at the moment. From the recorder 20 and the recorder 30 which have responded to that request, the network I/F 44 acquires the identifiers of the optical disks that are mounted. If no optical disk is mounted, an identifier indicating an unmounted state is sent. The CPU 41 executes a comparison between the identifiers which have been acquired via the network 10 and the identifier (contained in the scheduling information) of a storage medium which has been designated as a recording destination of a program. Then, based on the result of comparison, the CPU 41 instructs the recorder 20 or the recorder 30 to record the broadcast program. Specifically, if the result of comparison indicates a match, the CPU 41 instructs whichever one of the recorder 20 and the recorder 30 that has the optical disk of that identifier mounted thereon to record the broadcast program. On the other hand, if the result of comparison indicates a non-match, the CPU 41 instructs the recorder 20 having the hard disk 205b to record the scheduled broadcast program.

Next, referring back to FIG. 2, the processes performed in the scheduling system 110 will be specifically described. Prior to a scheduling of videorecording, the scheduling setting section 401 of the videorecording scheduling device 40 acquires EPG data from the recorder 20, which is connected to the network 10. Next, the scheduling setting section 401 of the videorecording scheduling device 40 instructs the recorder 20 and the recorder 30, which are connected to the network 10, to send information concerning a storage medium in each device. The recorder 20 transfers the information of the accommodated storage media, i.e., information of the optical disk 205a and the hard disk 205b, to the videorecording scheduling device 40.

Herein, the information of the optical disk 205a is: that it is a removable storage medium; its remaining recordable duration; its write protection state; and the value of its identifier “2011”. A write protection state of an optical disk represents whether recording of information onto that optical disk is prohibited or permitted. In many cases, the write protection state is set via a notch or the like on a cartridge (not shown) which accommodates the optical disk. However, in some cases, the write protection state may be recorded on the disk through software means, for example.

The information of the hard disk 205b is: that it is an unexchangeable storage medium; and its remaining recordable duration. It is expected that the hard disk, which is a non-removable storage medium, will never be exchanged, i.e., taken out of the device. Therefore, it does not have a write protection state or an identifier.

The recorder 30 transfers the information of the storage medium accommodated therein, i.e., the optical disk 305, to the videorecording scheduling device 40. Herein, the information of the optical disk 305 is: that it is a removable storage medium; its remaining recordable duration; its write protection state; and the value of its identifier “3011”. The scheduling setting section 401 of the videorecording scheduling device 40 receives these pieces of information, and stores them to the medium storage section 403 together with the network addresses of the recorders which have sent out the information.

Note that the aforementioned remaining recordable duration may read as “remaining recordable data amount” instead.

The videorecording scheduling device 40 of the present embodiment receives scheduling information as to which storage medium a recording of the program is to be performed for, and keeps scheduled items for the respective storage media under management. Specifically, as for any optical disk that is a removable storage medium, the identifiers which differ from optical disk to optical disk are associated with the individual schedules so as to be kept under management. As for the hard disk, which is a non-removable storage medium, the network address of the recorder is associated with the individual schedule items so as to be kept under management.

When a request for a scheduled videorecording is made from the user, the scheduled item displaying section 402 of the videorecording scheduling device 40 displays the scheduling status of each storage medium. FIG. 5 shows an exemplary display screen of videorecording status/scheduling status. FIG. 5 only illustrates the scheduling statuses. When a videorecording is completed, an indication of such will be added. As shown, the scheduling status of each storage medium is displayed in a single vertical row, so that the user can easily view the recorded substances on each optical disk. The user's schedule is displayed, as blocks in the vertical row for each storage medium, with a videorecording start time, a videorecording end time, a channel, and program title information which is acquired from the EPG data. Note that, with respect to the single vertical row of scheduling status indication for each optical disk, it is indicated in each row as to which recorder a target optical disk is currently inserted, in order to clarify to the user as to whether each storage medium that is a target of scheduling is inserted in a recorder or not.

When a videorecording is to be scheduled, the user first selects a storage medium to be scheduled, i.e., selects whichever one of the optical disks or the hard disk is to become a target. The selection of a storage medium is performed, while using move keys along the horizontal direction on the remote control 50, and with a horizontal scroll of the screen if necessary, by moving a cursor along the horizontal direction on the screen of FIG. 5. Next, by using up and down move keys on the remote control 50, the user moves the cursor to a new scheduling box which is indicated at the lowermost portion of the screen of FIG. 5 as either “Schedule a videorecording on this optical disk” or “Schedule a videorecording on this HDD”. Then, if the user presses a finalize key on the remote control 50, a scheduling setting screen is displayed, thus transitioning to a scheduling setting mode.

FIG. 6 shows an exemplary scheduling setting screen when a program whose title is “A” is to be scheduled with respect to the optical disk 305 having an identifier “3011”. When the scheduling setting mode is entered by way of a new scheduling box, an indication of scheduling setting for the optical disk of the identifier “3011” is automatically selected and highlighted.

On the scheduling setting screen, the user sets a videorecording start time and a channel. Based on the videorecording start time and the channel, the videorecording scheduling device 40 acquires a title name and a videorecording end time of that program, by using the EPG function. When the setting is finished, the user is asked to confirm whether or not make the scheduling. If the user moves the cursor to “Yes” and presses the confirm key, the scheduling is established.

Next, with reference to FIG. 7, an operation of the videorecording scheduling device 40 when executing a scheduled videorecording will be described. FIG. 7 shows a procedure of processing by the scheduling setting section 401 of the videorecording scheduling device 40. Note that, for simplicity of illustration, this flowchart only illustrates the important portions of the process.

Hereinafter, the processing will be described with reference to three typical cases, that is:

(1) a process when videorecording is normally performed;

(2) a process when an optical disk which is a target of scheduling is not mounted in any recorder; and

(3) a process when, although an optical disk is inserted, that optical disk is not recordable.

Firstly, (1) a process when videorecording is normally performed will be described.

In the scheduled program shown in FIG. 5, an example will now be described where a program title B is normally recorded onto the optical disk 205a having a medium identifier “2011”. Hereinafter, it is assumed that the optical disk 205a is mounted in the recorder 20.

The process is begun a certain amount of time before (preferably 10 minutes before) a point of time at which a videorecording is scheduled. First, at step S010, the scheduling setting section 401 of the videorecording scheduling device 40 instructs the recorder 20 and the recorder 30, which are connected to the network 10, to send information concerning storage media.

The network control sections 214 of the recorder 20 and the recorder 30 are always kept powered, so that any instruction which is sent via the network 10 can always be received. When an instruction is received from the videorecording scheduling device 40, the network control section 214 can power on the recorder so as to enable the entire recorder to function. Therefore, even if each recorder appears to be powered off, the recorder can receive an instruction from the videorecording scheduling device 40 to perform processing, and return a response to that instruction back to the videorecording scheduling device 40. Such a function utilizing the network control section 214 can be realized by, for example, implementing WOL (Wake On LAN) or a similar function.

Upon receiving an instruction from the videorecording scheduling device 40, the recorder 20 and the recorder 30 each transfer the information of a storage medium mounted therein to the videorecording scheduling device 40. The substance of this information is: whether it is a removable or non-removable storage medium; its remaining recordable duration (remaining recordable data amount); its write protection state, and the value of its identifier. The reason why the timing with which the scheduling setting section 401 gives an instruction to send information concerning storage media is not immediately before the point of time at which the videorecording is scheduled is that, if there arises a situation where the videorecording cannot be executed, a time margin will be needed for giving an alarm for the user and allowing the user to take necessary actions. In addition, once the presence of a disk is confirmed a considerable period of time before the point of time at which a videorecording is scheduled, the disk is locked following the confirmation, so that the recorder can no longer be used until the lock is canceled. If the lock is manually cancelled, re-locking may be forgotten and the videorecording may fail.

At step S020, the scheduling setting section 401 of the videorecording scheduling device 40 receives from each recorder the information of a storage medium mounted therein, and confirms that the optical disk 205a which is the target of videorecording is present. Specifically, the scheduling setting section 401 acquires the identifier “2011” to confirm that the optical disk 205a is present. Furthermore, at the next step 030, the scheduling setting section 401 confirms that the optical disk 205a is placed in the recorder 20.

Next, at step S040, the scheduling setting section 401 confirms that the optical disk 205a is not write-protected, that is, the optical disk 205a is recordable. After confirmation, the process proceeds to step S050.

At step S050, the scheduling setting section 401 confirms that the remaining recordable duration of the optical disk 205a is equal to or greater than the broadcasting duration of the program to be recorded. For example, if a remaining recordable duration is given from the recorder 20, the scheduling setting section 401 may compare that duration against the broadcasting duration of the scheduled program. If a remaining recordable data amount is given from the recorder 20, the scheduling setting section 401 may calculate a remaining recordable duration by dividing the value of that data amount by a bit rate at videorecording (which is designated at the time of scheduling), and compare it against the broadcasting duration of the scheduled program. If the remaining recordable duration of the optical disk 205a is equal to or greater than the broadcasting duration of the program to be recorded, the process proceeds to step S060.

At step S060 and later, the scheduling setting section 401 causes the recorder 20 to execute videorecording. First at step S060, an instruction to lock the disk is given, in order to cause the recorder 20 to prohibit unloading of the disk. The reason for locking is to prevent the user from inadvertently taking out the disk under recording, immediately before the scheduled videorecording or during the scheduled videorecording.

Next, the scheduling setting section 401 sends scheduling information to the recorder 20. This scheduling information at least includes: that the target medium is the optical disk 205a having the identifier “2011”; a videorecording start time and a videorecording end time; and channel information. At step S070, the scheduling setting section 401 instructs the recorder 20 to execute the scheduled videorecording in accordance with the scheduling information. In response, the recorder 20 performs a videorecording in accordance with the scheduling information. At step S080, after completion of the videorecording, the scheduling setting section 401 instructs the recorder 20 to unlock the disk.

Note that the above illustration assumes that the optical disk 205a is mounted in the recorder 20. If the optical disk 205a were mounted in the recorder 30, the only difference would be that the scheduling setting section 401 would output instructions to the recorder 30, with the rest being the same.

Note that a scheduling of videorecording may also be performed for the hard disk 205b. The scheduling setting operation in this case is generally the same as the process of a scheduling of videorecording for the optical disk 205a. However, disk locking and cancellation of locking are not performed because they are unnecessary. As for the designation of a target storage medium, it is not particularly necessary to designate an identifier. Simply the hard disk may be designated.

Next, still referring to FIG. 7, (2) a process when an optical disk which is a target of scheduling is not mounted in any recorder will be described. In the following description, it is assumed that the optical disk 305 having the identifier “3011” is mounted in neither the recorder 20 nor the recorder 30. For simplicity of illustration, the description of any operation which is identical to what is described above will be omitted.

A certain amount of time before the point of time at which a videorecording is scheduled, the scheduling setting section 401 instructs the recorder 20 and the recorder 30 to send information concerning storage media. The recorder 20 and the recorder 30 each transfer the information of a storage medium mounted therein to the videorecording scheduling device 40. Since the identifier “3011” is not present under the aforementioned condition, the scheduling setting section 401 determines that the optical disk 305 is not present. As a result, the process proceeds to step S110.

Note that, even if an optical disk or the like is mounted in a recorder, its identifier may not be able to be read due to contamination on the optical disk or the like. Moreover, if no optical disk is mounted in a recorder in the first place, there is no identifier to be read. In such cases, information indicating that no identifier is detected, or an identifier having a specific value may be sent as the information of a storage medium. Thus, the scheduling setting section 401 is able to determine that the optical disk which is the target of scheduling is not mounted in the recorder which has transmitted it. The scheduling setting section 401 of the videorecording scheduling device 40 receives from each recorder the information concerning a storage medium or information indicating that no identifier is detected, and stores it to the medium storage section 403.

At step S110, the scheduled item displaying section 402 indicates an alarm on the display device 410 that “the optical disk 305 which is the target of scheduling is not inserted in the recorder”, because there exists an error state where the optical disk 305 which is the target of scheduling is placed in neither recorder.

If the error state is not eliminated until immediately before the start time of the scheduled videorecording, at step S120, the scheduling setting section 401 searches for another storage medium to perform an emergency recording of the program which is the target of scheduling. Specifically, the scheduling setting section 401 refers to the information concerning the storage medium in each recorder as stored in the medium storage section 403. At this time, as a target of emergency recording, the scheduling setting section 401 searches for a non-removable storage medium (also called a fixed storage medium) with a higher priority. The reason for searching for a fixed storage medium with a higher priority is that, if an emergency recording is performed on an optical disk which is unloadable, the optical disk may be taken out by another user, thus making it difficult for the user who has set the scheduling to view that program. Note that, the hard disk, as an example of a non-removable storage medium, is generally able to guarantee a longer recording duration than do usual optical disks, so that an emergency recording is unlikely to cause shortage in its remaining recording duration such that other scheduled videorecordings cannot be executed. Therefore, it is advantageous to allocate a fixed storage medium as a target of an emergency recording, with a higher priority. In the present embodiment, the scheduling setting section 401 selects the hard disk 205b in the recorder 20 as a target of emergency recording. Note that, in an emergency recording, a scrambling that can only be cancelled by the user who has performed the videorecording can be applied to the recorded program. This ensures that no other user can access the recorded substances on the storage medium which is the destination of emergency saving, whereby the privacy of the user who has set the scheduling is protected. Such scrambling is cancelled when the user inputs a previously-set password, for example.

At step S130, the scheduling setting section 401 confirms whether or not videorecording is possible on the recorder 20, which is the target of emergency recording. For example, the scheduling setting section 401 inquires the recorder 20 as to the remaining recordable duration on the hard disk 205b or the videorecording durations of any programs whose videorecording is scheduled, and obtains the information of such durations. Then, if the total time of the recording duration of the program to be subjected to an emergency recording and the recording durations is shorter than the remaining duration, it is determined that videorecording is possible. Alternatively, it may be determined that videorecording is possible if the remaining recordable duration on the hard disk 205b is longer than the recording duration of the program to be subjected to an emergency recording.

Although steps S120 and 130 are described as separate processing blocks, they may be integrated. In that case, the medium storage section 403 of the videorecording scheduling device 40 may acquire the information of the aforementioned durations in advance, and when searching for a non-removable storage medium with a higher priority, take such information into consideration in determining a storage medium on which to perform the emergency recording.

At step S140, to the recorder 20, the scheduling setting section 401 of the videorecording scheduling device 40 sends scheduling information which includes the information that the target medium is the hard disk 205b, the videorecording start time and the videorecording end time, channel information, etc., and instructs the recorder 20 to execute the scheduled videorecording based on the scheduling information. Also, the scheduling setting section 401 may receive information that it is an emergency recording. As a result, the recorder 20 records the program based on the scheduling information.

Then, at step S150, the scheduled item displaying section 402 displays the details of the emergency recording on the scheduling table, after the videorecording is completed. The determination as to whether the videorecording has been completed or not can be made by, for example, ascertaining the point of time of videorecording completion based on the videorecording end time in the scheduling information. In order to display the details of the emergency recording, based on an instruction from the CPU 41 (which is a part of the scheduled item displaying section 402), a video signal corresponding to a screen to be displayed by the graphic circuit 43 may be generated and output to the display device 410. When displaying videorecording statuses, the scheduled item displaying section 402 adds a block for the hard disk 205b, and in this block, indicates that an emergency recording has been performed, together with the details of the emergency recording (i.e., the videorecording start time, videorecording end time, channel, and program title information). At the same time, in the block of the scheduling for the optical disk 305, occurrence of an error is indicated, and also the hard disk in the recorder 20 is indicated as information of a location where an emergency recording of the scheduled program has been performed. These indications are made in an enhanced manner so as to draw the user's attention.

FIG. 8 shows an exemplary display screen which includes an error indication 80 for the optical disk having the identifier “3011” and an alert indication 81 of an emergency recording. By moving the cursor to the error indication 80 of the optical disk in question (identifier “3011”) and pressing the execution button, the user is able to confirm the result of the scheduled videorecording.

FIG. 9 shows an exemplary display screen of a result of a scheduled recording with respect to a program for which the error indication 80 has been given. By referring to this display screen, the user can learn the details of the error (i.e., “no disk at execution of schedule”). On the display screen, a button for moving the data of the program which has been subjected to an emergency recording to the optical disk which was originally the target of scheduling is provided. For example, the user inserts the optical disk 305 in the recorder 30, moves the cursor to the selection button on this screen, and presses the execution button on the remote control 50. Then, the scheduling setting section 401 gives an instruction to move the program data from the hard disk 205b in the recorder 20 to the optical disk 305 in the recorder 30. A move is defined as a process of copying information from one storage medium to another storage medium, and thereafter deleting that information from the original storage medium. As a result, the program which has been subjected to an emergency recording can be moved from the hard disk 205b to the optical disk 305 which was originally the target of scheduling.

The execution details of the move process are as follows. For example, when the execution button is pressed, the videorecording scheduling device 40 requests the recorders 20 and 30 to transmit identification information of optical disks which are mounted therein at the moment. As a result, the identifier “3011” is returned from the recorder 30, and thus the scheduling setting section 401 confirms that the optical disk 305 is mounted in the recorder 30. At this time, the write protection information and the remaining recordable duration information of the optical disk 305 are also sent, and based on these pieces of information, the scheduling setting section 401 also confirms that recording to the optical disk 305 is possible. Next, the scheduling setting section 401 confirms that the identifier “3011” matches the identifier “3011” which is designated for the program on the hard disk 205b in the recorder 20. Then, the scheduling setting section 401 sends the address (on the network) of the recorder 30 to the recorder 20, and instructs the recorder 20 to move the data of the program in question on the hard disk 205b to the recorder 30. In response to this instruction, a move process of the program in question is executed between the recorders 20 and 30.

Note that the scheduled item displaying section 402 shown in FIG. 8 is able to generate the display screen shown in FIG. 8 because it grasps the scheduling statuses and videorecording statuses within the scheduling system 110. On the other hand, the recorders 20 and 30 may each generate and display a listing of recorded programs on the optical disk which is mounted therein or in its built-in hard disk. The recorder 20 will generate a listing of recorded programs concerning all recordable media. In the present embodiment, since the recorder 20 is able to record programs on both of the optical disk 205a and the hard disk 205b, separate rows will be given to the respective storage media in generating a listing table.

For example, FIG. 10 shows an exemplary display screen of a listing of Recorded programs which has been generated by the recorder 20. It shows that, three programs are recorded on the optical disk having the identifier “2011” which is mounted in the recorder 20, including the program of the title B. On the other hand, on the HDD in the recorder 20, two programs are recorded in addition to the program of the program title A, which has been subjected to an emergency recording. In the case where information indicating an emergency recording is received from the scheduling setting section 401, the recorder 20 can generate the indication 81 for the program of the title A that it has been subjected to an emergency recording.

Furthermore, referring back to FIG. 7, (3) a process when, although an optical disk is inserted, that optical disk is not recordable will be described. Examples of not being recordable include: (3a) when the optical disk which is the target of scheduling is write-protected; and (3b) when the remaining videorecordable duration of the optical disk is shorter than the broadcasting duration of the program which is the target of scheduled videorecording. Hereinafter, these examples will be described. For simplicity of illustration, the description of any operation which is identical to what is described above will be omitted.

Firstly, the process of (3a) when the optical disk which is the target of scheduling is write-protected will be described.

A certain amount of time before the point of time at which a videorecording is scheduled, the scheduling setting section 401 of the videorecording scheduling device 40 instructs the recorder 20 and the recorder 30 to send information concerning storage media. The information concerning a storage medium which is transferred from the recorder 30 to the videorecording scheduling device 40 also includes information indicating a write protection state (write protection information). In this example, it is assumed that the write protection information of only the optical disk 305 of the identifier “3011” indicates “ON”.

After receiving the write protection information and storing it to the medium storage section 403, at step S040, the scheduling setting section 401 determines that the optical disk 305 which is the target of videorecording is unrecordable. Then, at step S110, the scheduled item displaying section 402 indicates an alarm on the display device 410 that “the optical disk 305 which is the target of scheduling is write-protected”, thus notifying an error state. If the error state is not eliminated until immediately before the start time of the scheduled videorecording, the scheduling setting section 401 searches for another storage medium on which to perform an emergency recording of the program to be scheduled. The ensuing operation is similar to the above-described case where no disk is inserted, except that the details of the error which is output by the scheduling setting section 401 is “unrecordable at execution of schedule” in this case.

Next, the process of (3b) when the remaining recordable duration of the optical disk which is the target of videorecording scheduling is shorter than the broadcasting duration of the program which is the target of scheduled recording will be described. For simplicity of illustration, the description of any operation which is identical to what is described above will be omitted. Although a recorder usually supports a plurality of videorecording duration modes by controlling image quality, it is assumed for simplicity of illustration that there is only one videorecording duration mode.

A certain amount of time before point of time at which a videorecording is scheduled, the scheduling setting section 401 of the videorecording scheduling device 40 instructs the recorder 20 and the recorder 30 to send information concerning storage media. The information concerning a storage medium which is transferred from the recorder 30 to the videorecording scheduling device 40 also includes remaining duration information indicating a remaining recordable duration. In this example, it is assumed that the remaining duration information indicates a shorter period of time than the recording duration of the program.

After receiving this information and storing it to the medium storage section 403, at step S050, the scheduling setting section 401 determines that the optical disk 305 which is the target of videorecording does not have enough remaining recording duration. Then, at step S110, the scheduled item displaying section 402 indicates an alarm on the display device 410 that “the optical disk 305 which is the target of scheduling does not have enough remaining recording duration”, thus notifying an error state. If the error state is not eliminated until immediately before the start time of the scheduled videorecording, the scheduling setting section 401 searches for another storage medium on which to perform an emergency recording of the program to be scheduled. The ensuing operation is similar to the above-described case where no disk is inserted, except that the details of the error which is output by the videorecording scheduling setting section 401 is “not enough recordable duration” in this case. Note that, in order to cancel the error state, the user needs to make it possible for the scheduled program to be recorded, by erasing other programs on the optical disk 305, for example.

Thus, an embodiment of the scheduling system according to the present invention has been described above. In the scheduling system, it is assumed that the videorecording scheduling device and the recorders are separate devices. However, this is only an example, and any other various forms may be taken. Now, referring to FIGS. 11(a) and (b), other arrangements of the scheduling system will be described. In FIGS. 11(a) and (b), a videorecording scheduling device having similar functions to those of the videorecording scheduling device 40 of FIG. 2 will be denoted as a “videorecording scheduling device 40a”, a “videorecording scheduling device 40b”, and so on. The same also applies to the recorders.

FIG. 11(a) shows the arrangement of a second scheduling system 110a according to the present embodiment. In the scheduling system 110a, a videorecording scheduling device 40a and a recorder 20a are provided within a single housing, thus to operate as a single recording device 25 combining the functions of both. The videorecording scheduling device 40a and the recorder 20a are interconnected via a signal line (bus) within the recording device 25. This bus has a similar function to that of the network 10 in FIG. 2. Therefore, the scheduling system 110a has similar functions to those of the scheduling system 110. The recording device 25, including the videorecording scheduling device 40a and the recorder 20a, is connected to a recorder 30a via a home network, and is also connected to a public network. The user is able to perform scheduling of videorecording not only via a remote control 50, but also via a mobile phone 60. Once reception of scheduling of videorecording is completed, the videorecording scheduling device 40a requests the recorder 20a and the recorder 30a to transmit information concerning storage media. The ensuing process is as described in connection with the scheduling system 110.

FIG. 11(b) shows the arrangement of a third scheduling system 110b according to the present embodiment. A videorecording scheduling device 40b is connected to a recorder 20b and a recorder 30b via a public network and a home network. The videorecording scheduling device 40b is a server of an Internet service provider (ISP), for example. This server has an EPG function, and the user can set scheduling of videorecording by referring to an EPG. On the other hand, the recorder 20b and the recorder 30b receives from the videorecording scheduling device 40b a request to transmit information concerning storage media, and executes videorecording based on the scheduling information. Since the videorecording scheduling device 40b is furnished with the EPG function, there is no need to furnish the recorders 20b and 30b with the EPG function. Therefore, the increase in the manufacturing cost of each recorder can be suppressed.

Note that the aforementioned ISP server does not need to be implemented in a single housing only. For example, a web server corresponding to the scheduling setting section 401 and the scheduled item displaying section 402 of the videorecording scheduling device 40 may be constructed on a single server PC, while a database server corresponding to the medium storage section 403 may be constructed on a server PC. The physical locations of the server PCs may be close to or distant from each other.

When requests to transmit information concerning storage media or scheduling information is sent from the videorecording scheduling device 40b to the recorder 20b and the recorder 30b via a network, an e-mail may be transmitted to each recorder. It is assumed that the recorder 20b and the recorder 30b each have an e-mail address preassigned thereto. Each recorder accesses a mail server (not shown) with a predetermined timing to receive any mail which is directed thereto. When an e-mail is received, each recorder analyzes its message, and acquires the request to transmit information concerning storage media, scheduling information, or the like. An e-mail is also transmitted from each recorder to the videorecording scheduling device 40b, and a response to the request is returned.

According to the present embodiment, a user can perform scheduling of videorecording while designating a storage medium. At this time, the display device displays a scheduling setting screen in which scheduled items are arranged in one row for each storage medium. Since each storage medium can be identified based on a unique medium identifier, it is possible to detect an device in which the target storage medium is placed and perform scheduling of videorecording for that device. Irrespective of which device on the network a storage medium is inserted when executing a scheduled videorecording, a videorecording to the target storage medium can be performed.

Moreover, in the present embodiment, an error is indicated when a difficulty in performing a scheduled videorecording on a scheduled storage medium is detected. Then, if the error state is not eliminated, an emergency recording to a storage medium in another device on the network is performed. This prevents failures in scheduled recording of broadcast programs, which are of transient nature. By assigning a non-removable storage medium as the destination of emergency recording with a higher priority, it is made easier for the user to access the program which has been subjected to an emergency recording.

Also according to the present invention, when an emergency recording is performed, the details of the emergency recording are indicated on the scheduling table, thus making it easy for the user to know the storage medium on which the program which has been scheduled for recording has been subjected to an emergency recording. Furthermore, there is provided an operation screen for moving the program which has been subjected to an emergency recording to the storage medium which was originally the target of scheduling, thus assisting in the user's creation of a library even in the case of failing in scheduled recording.

Note that the present embodiment assumes that the storage media are DVD-RAMs and that the identifier of each storage medium is a number which is recorded in the BCA area. However, any kind of information may be used as the identifier so long as it contains information for enabling the identification of each individual optical disk, and the identifier may be retained at any position. For example, it may be RFID, a bar code, unique data which is recorded in a certain area of the storage medium, or the like. Alternatively, information in a specific area on the storage medium or information in a specific logical field may be utilized, e.g., a disk name which has been input by the user or automatically designated by the recorder.

Moreover, in the present embodiment, the substance of each storage medium identifier is displayed on the scheduling screen so as to make it easy for the user to identify the storage medium. However, it may not be easy to identify each storage medium if the substance of the storage medium identifier is a mere numerical value or a sequence of alphabetical letters. Therefore, the substance of the storage medium identifier does not need to be indicated as it is unless it is easy for the user to understand. For example, the medium identifier and a disk identification name that has been set by the user may be stored in association with each other on the medium scheduling device, and only the user-set disk identification name may be displayed on the scheduling screen, instead of the medium identifier.

In the aforementioned listing screen of scheduling statuses, scheduling statuses pertaining to other users may also be displayed. This makes it possible to prevent any same program from being redundantly scheduled for recording. However, in order to protect privacy, an ability may be provided to set whether or not to disclose the name of each scheduling person. As for any schedule item which is designated not to disclose the name of the scheduling person, the scheduling person will not be displayed, but only the number of people or the presence or absence of the schedule item may be displayed.

In the present embodiment, the videorecording scheduling device requests each recorder for information concerning a storage medium. However, each recorder may notify to the videorecording scheduling device the information concerning a storage medium mounted therein, at the time when the storage medium is exchanged or the recorder is powered on, for example.

Moreover, the present invention may also be realized on the basis of a computer program which defines the processing procedure shown in FIG. 7. A computer (e.g., a CPU) in the videorecording scheduling device can execute such a computer program to cause each component element within the device to operate for realizing the aforementioned processes. The computer program is marketed in a form recorded on a storage medium such as a CD-ROM, or transmitted via an electrical communication network such as the Internet. Thus, the computer system can be allowed to operate as an device having similar functions to those of the videorecording scheduling device described above.

### INDUSTRIAL APPLICABILITY

The present invention introduces the concept of scheduling to a storage medium, thus being significantly different from the conventional concept of scheduling to an device, and therefore is very useful in the following purposes and aspects.

Specifically, a user usually manages programs on a storage medium-by-storage medium basis. For example, a specific sports program may be recorded to one disk, while a serial drama may be recorded to another disk, and so on. According to the present invention, the user can designate a target storage medium when performing a scheduling of videorecording, and therefore it is possible to perform videorecording to the target disk without paying particular attention as to which device has the storage medium inserted therein at the time of executing the scheduled videorecording. This will prove to be very convenient when the number of recording devices owned by the user increases in the future. Moreover, the present invention is free from restrictions as to the type of storage medium, and therefore is applicable to devices and systems which use not only optical disks but also removable storage media, e.g., memory cards.

Moreover, the present invention is applicable to any purposes other than the purpose of recording a television broadcast program which is transmitted from a broadcast station. For example, the present invention is also applicable to the recording of a program which consists only of music, and the recording of multimedia information which is distributed via the Internet, cable television, etc., for example.

Furthermore, with the prevalence of the Internet, various web services are beginning to be provided. It would also be possible to provide a videorecording scheduling service by utilizing a server on the Internet to realize the functions of the videorecording scheduling device.

1. A scheduling device for instructing one of one or more recording devices which are interconnected via a network to record a content based on scheduling information,
wherein the scheduling information contains identification information of a removable storage medium on which the content is to be recorded, and time information specifying a recording start time and a recording end time of the content, the scheduling device comprising:
a storing section for storing the scheduling information;
a communication section for acquiring, from a recording device among the one or more recording devices that is capable of mounting the removable storage medium, identification information specifying a removable storage medium which is mounted in the recording device at a time a predetermined amount of time before the recording start time; and
a control section for executing a comparison between the acquired identification information and the identification information contained in the scheduling information, and giving an instruction to record the content based on a result of comparison.

2. The scheduling device of claim 1, wherein, when the result of comparison indicates a match, the control section instructs the recording device having the removable storage medium mounted therein to record the content.

3. The scheduling device of claim 2, wherein the control section transmits the scheduling information to the recording device which is instructed to record the content, and instructs the recording device to record in accordance with the scheduling information.

4. The scheduling device of claim 2, wherein,
a recording device having a non-removable storage medium which is capable of recording the content is connected to the network; and
when the result of comparison indicates a non-match, the control section instructs the recording device having the non-removable storage medium to record the content.

5. The scheduling device of claim 4, wherein,
from the recording device having the removable storage medium mounted therein, the communication section further acquires write protection information indicating whether recording to the removable storage medium is prohibited or permitted; and
based on the write protection information, the control section instructs the recording device having the removable storage medium mounted therein to record the content when recording is permitted, and instructs the recording device having the non-removable storage medium to record the content when recording is prohibited.

6. The scheduling device of claim 4, wherein,
from the recording device having the removable storage medium mounted therein, the communication section further acquires remaining duration information indicating a remaining recordable duration on the removable storage medium; and
based on the time information and the remaining duration information, the control section instructs the recording device having the removable storage medium mounted therein to record the content when recording the entire content to the removable storage medium is possible, and instructs the recording device having the non-removable storage medium to record the content when recording is impossible.

7. The scheduling device of claim 4, further comprising a signal processing section for generating a notification signal for notifying a completion of recording when the recording of the content to the non-removable storage medium has been completed.

8. The scheduling device of claim 4, wherein,
after the recording of the content to the non-removable storage medium is completed, the communication section again acquires, from the recording device that is capable of mounting the removable storage medium, identification information specifying a removable storage medium mounted therein; and
the control section executes the comparison based on the identification information acquired again and the identification information contained in the scheduling information, and when determining that recording of the content to the removable storage medium is possible based on a result of comparison, instructs the recording device having the non-removable storage medium and the recording device having the removable storage medium to move the content from the non-removable storage medium to the removable storage medium.

9. The scheduling device of claim 4, wherein the communication section again acquires the identification information from a recording device that is capable of mounting the removable storage medium and has the non-removable storage medium.

10. A method of instructing one of one or more recording devices which are interconnected via a network to record a content based on scheduling information,
wherein the scheduling information contains identification information of a removable storage medium on which the content is to be recorded, and time information specifying a recording start time and a recording end time of the content, the method comprising the steps of:
acquiring the scheduling information;
acquiring, from a recording device among the one or more recording devices that is capable of mounting the removable storage medium, identification information specifying a removable storage medium which is mounted in the recording device at a time a predetermined amount of time before the recording start time;
executing a comparison between the acquired identification information and the identification information contained in the scheduling information; and
giving an instruction to record the content based on a result of comparison.

11. A recording device for executing a recording of a content to a removable storage medium mounted therein, based on an instruction from a scheduling device which is interconnected via a network, wherein,
the removable storage medium retains identification information for identifying each of removable storage media, the recording device comprising:
a communication section for communicating with the scheduling device;
a drive control section for reading identification information of a mounted removable storage medium; and
a control section for, based on an instruction from the scheduling device to transmit the identification information, giving an instruction to read the identification information and giving an instruction to transmit the identification information having been read, wherein,
based on an instruction from the scheduling device to record the content, the control section gives an instruction to record the content onto the removable storage medium, and based on the instruction from the control section, the drive records the content onto the removable storage medium.

12. The recording device of claim 11, further comprising a non-removable storage medium capable of recording the content, wherein,
from the scheduling device, the communication section receives the instruction to record the content together with an instruction specifying a storage medium on which the content is to be recorded; and,
based on the instruction, the drive control section records the content onto one of the non-removable storage medium and the removable storage medium.

13. The recording device of claim 12, wherein,
after the recording of the content onto the removable storage medium is completed,
the control section generates a listing of all contents that are recorded on the removable storage medium and the non-removable storage medium.

14. The recording device of claim 13, wherein the control section generates the listing by arranging, in associated with each other, the identification information of the removable storage medium and time information concerning a point of time at which the recording was performed.

15. The recording device of claim 14, wherein the control section generates the listing without utilizing data of an electronic program guide which is contained in a broadcast wave.
